(19) United States
(12) Patent Application Publication
(10) Pub. No.: US 2016/0196205 A1
(43) Pub. Date: Jul. 7, 2016

(54) METHOD AND APPARATUS FOR ACCESSING REMOTE MOBILE DEVICES

(71) Applicant: DEVICE ON CLOUD, INC., San Francisco, CA (US)

(72) Inventors: Jakub BUSZYNSKI, Buk (PL); Marcin GASPEROWICZ, Poznan (PL)

(21) Appl. No.: 14/988,546

(22) Filed: Jan. 5, 2016

Related U.S. Application Data
(60) Provisional application No. 62/099,839, filed on Jan. 5, 2015.

(51) Int. Cl. G06F 11/36; G06F 9/44

(52) U.S. Cl. CPC G06F 11/3696; G06F 8/76

(57) ABSTRACT

A method and apparatus may include accessing a plurality of different remote mobile devices. Different technical characteristics exist across the different remote mobile devices. The method may also include providing a first input. The first input is translated into a second input. The second input is received by at least one remote mobile device. The first input is translated into the second input based on the technical characteristics specific to the at least one remote mobile device. The method may also include determining a response to the second input by the at least one remote mobile device.

### BACKGROUND

1. Field

Certain embodiments of the present invention relate to accessing remote mobile devices, and to controlling the remote mobile devices.

2. Description of the Related Art

Application developers are commonly developing mobile applications for personal computing devices, such as for mobile phones, personal tablets, and personal digital assistants, for example. When an application developer develops an application that is to be used across a wide variety of personal computing devices, the application developer may need to consider how the application will appear/operate across different screen sizes, different hardware specifications, and/or different configurations of the differing computing devices.

### SUMMARY

According to a first embodiment, a method may include accessing, by an end-user device, a plurality of different remote mobile devices. Different technical characteristics exist across the different remote mobile devices. The method may also include providing a first input. The first input may be translated into a second input. The second input is received by at least one remote mobile device. The first input may be translated into the second input based on the technical characteristics specific to the at least one remote mobile device. The method may also include determining a response to the second input by the at least one remote mobile device.

In the method of the first embodiment, the providing the first input may include providing a test scenario.

In the method of the first embodiment, the test scenario may include a swipe input, and the translation of the test scenario may include translating the test scenario based on a physical dimension of the at least one remote mobile device.

In the method of the first embodiment, the accessing may include accessing the plurality of different remote mobile devices by the end-user device via a network.

In the method of the first embodiment, the plurality of different remote mobile devices may include at least one virtual machine that is provided by a virtual device unit.

In the method of the first embodiment, the determining the response may include converting data from a low level of an operating system of the at least one remote mobile device to a format viewable by the end-user device.

According to a second embodiment, an apparatus may include at least one processor. The apparatus may also include at least one memory including computer program code. The at least one memory and the computer program code may be configured, with the at least one processor, to cause the apparatus at least to access a plurality of different remote mobile devices. Different technical characteristics exist across the different remote mobile devices. The apparatus may also be caused to provide a first input. The first input may be translated into a second input, the second input is received by at least one remote mobile device, and the first input is translated into the second input based on the technical characteristics specific to the at least one remote mobile device. The apparatus may also be caused to determine a response to the second input by the at least one remote mobile device.

In the apparatus of the second embodiment, the providing the first input may include providing a test scenario.

In the apparatus of the second embodiment, the test scenario may include a swipe input, and the translation of the test scenario may include translating the test scenario based on a physical dimension of the at least one remote mobile device.

In the apparatus of the second embodiment, the accessing may include accessing the plurality of different remote mobile devices by the apparatus via a network.

In the apparatus of the second embodiment, the plurality of different remote mobile devices may include at least one virtual machine that is provided by a virtual device unit.

In the apparatus of the second embodiment, the determining the response may include converting data from a low level of an operating system of the at least one remote mobile device to a format viewable by the apparatus.

According to a third embodiment, a computer program product may be embodied on a non-transitory computer readable medium, the computer program product configured to control a processor to perform a method according to the first embodiment.

According to a fourth embodiment, a method may include providing, by a device unit, access to a plurality of different remote mobile devices for an end-user device. Different technical characteristics exist across the different remote mobile devices. The method may also include receiving a first input from the end-user device. The method may also include translating the first input into a second input. The first input is translated into the second input based on technical characteristics specific to at least one remote mobile device. The method may also include transmitting the second input to the at least one remote mobile device. The method may also include forwarding a response by the at least one remote mobile device to the second input. The response is forwarded to the end-user device.

In the method of the fourth embodiment, the receiving the first input may include receiving a test scenario.

In the method of the fourth embodiment, the test scenario may include a swipe input, and the translation of the test scenario may include translating the test scenario based on a physical dimension of the at least one remote mobile device.

According to a fifth embodiment, an apparatus may include at least one processor. The apparatus may also include at least one memory including computer program code. The at least one memory and the computer program code may be configured, with the at least one processor, to cause the apparatus at least to provide access to a plurality of different remote mobile devices for an end-user device. Different technical characteristics exist across the different remote mobile devices. The apparatus may also be caused to receive a first input from the end-user device. The apparatus may also translate the first input into a second input. The first input is translated into the second input based on technical characteristics specific to at least one remote mobile device. The apparatus may also transmit the second input to the at least one remote mobile device. The apparatus may also forward a response by the at least one remote mobile device to the second input. The response is forwarded to the end-user device.

In the apparatus of the fifth embodiment, the receiving the first input may include receiving a test scenario.

In the apparatus of the fifth embodiment, the test scenario may include a swipe input. The translation of the test scenario may include translating the test scenario based on a physical dimension of the at least one remote mobile device.

According to a sixth embodiment, a computer program product may be embodied on a non-transitory computer readable medium. The computer program product configured to control a processor to perform a method according to the fourth embodiment.

### BRIEF DESCRIPTION OF THE DRAWINGS

For proper understanding of the invention, reference should be made to the accompanying drawings, wherein:

FIG. 1 illustrates an example user interface of an end-user device in accordance with certain embodiments of the present invention.

FIG. 2 illustrates an example configuration in accordance with certain embodiments of the present invention.

FIG. 3 illustrates some benefits provided by certain embodiments of the present invention.

FIG. 4 illustrates providing inputs which may correspond to a test scenario, in accordance with certain embodiments of the present invention.

FIG. 5 illustrates a physical device unit that may be a part of a system which facilitates access to physical devices, in accordance with certain embodiments of the present invention.

FIG. 6 illustrates a physical device agent that facilitates exchange of relevant data, in accordance with certain embodiments of the present invention.

FIG. 7 illustrates a virtual device unit that may be a part of a system which facilitates access to virtual devices, in accordance with certain embodiments of the present invention.

FIG. 8 illustrates a flowchart of a method in accordance with certain embodiments of the invention.

FIG. 9 illustrates a flowchart of a method in accordance with certain embodiments of the invention.

FIG. 10 illustrates an apparatus according to certain embodiments of the present invention.

FIG. 11 illustrates another apparatus in accordance with certain embodiments of the invention.

FIG. 12 illustrates another apparatus in accordance with certain embodiments of the invention.

### DETAILED DESCRIPTION

Certain embodiments of the present invention generally relate to remote accessing of mobile devices and, in particular, to remote control of mobile devices. Embodiments of the present invention may be software-based and/or hardware based. Certain embodiments may be implemented as a system on a chip (SoC).

In developing an application that is useable/applicable across a wide variety of mobile devices, a developer of the application may need to account for technical differences across the variety of mobile devices. Because there may not be any standardized features/specifications across the variety of mobile devices, the technical differences across the mobile devices may be result in a fragmented development environment. This fragmentation occurring in the mobile device market presents a challenge for native and web application developers. Each type of mobile device may have a different hardware, a different operating system, and/or a different screen size compared to other types of mobile devices. In order to develop applications that are applicable/useable with all different types of mobile devices, developers generally need to have access to a wide range of different devices to, not only test if the application works, but also to be able to debug the application.

Certain embodiments of the present technology may be directed to a method and system for remote access and control of mobile devices. Certain embodiments may allow a user/developer to remotely interact with mobile devices in a manner that is native to the mobile devices. In other words, certain embodiments may allow a user/developer to remotely interact with a mobile device such that the life-like interaction appears to be a direct interaction with the remote mobile device.

With certain embodiments of the present invention, a mobile device may generally refer to a hardware device, for example, a smartphone, tablet, smartwatch, wearable device, a handheld computer, a device operating in conjunction with the internet of things, and/or a wearable screen (like Google Glass, for example).

With certain embodiments of the present invention, in order to allow a user/developer to remotely interact with mobile devices, different interfaces may be implemented. These interfaces may include human-to-computer and/or computer-to-human interfaces. Example interfaces may comprise touch screens, display screens, buttons, microphones, speakers, cameras, sensors (such as a compass, a light sensor, an accelerometer, a gyroscope, and/or a barometer, for example), universal-serial-bus (USB) ports, Bluetooth ports, lightning connectors to USB ports, high-definition-multimedia-interface (hdmi) ports, and/or mobile-high-definition-link (mhl) ports. Components of interfaces may correspond to modules or components of mobile devices. These interfaces may allow the developer/user to remotely access/control the mobile devices.

Certain embodiments of the present invention may implement a virtual machine, in order to represent a mobile device. A virtual machine (as described in more detail below) may correspond to, for example, a mobile-device operating system that is virtualized on a different software or hardware environment. A virtual machine may utilize hardware acceleration and/or may utilize a software bridge for enabling physical-mobile-device interfaces. Certain embodiments may also implement a system-on-chip (SOC) to represent a mobile device.

As described above, the fragmentation that is occurring within the mobile-device market presents a challenge for native and web-application developers. Each type of mobile device may have a different hardware, a different operation system, and/or a different screen size compared to other types of mobile devices. In order to develop responsive/useable applications that are applicable to all different types of mobile devices, developers generally need to test their applications on many different types of mobile devices to ensure that their applications work as expected.

In general, an application and/or software component may be installed on mobile devices such as, for example, smartphones, smartwatches, and/or or wearable screens (like Google Glass). Testing, and fixing bugs in such applications and/or software components generally involves inputting debugging commands, inputting touch and key events, and/or causing a change of position or location, for example. When developers test applications with a test scenario, the developers generally need to perform the same test scenario on multiple devices in order to compare the resulting behavior between the multiple devices, and to ensure that the proper behavior occurs on each of the multiple devices.

When developing applications that are applicable to different types of mobile devices, one approach is to purchase many mobile devices (and to manually perform application testing on these devices) in an attempt to develop an application that can be used on most of the popular mobile devices on the market. However, this approach has shortcomings from an economic and usability standpoint. Specifically, purchased mobile devices may have a long period of amortization and a short time of life on the market. Also, each device may only have one version of an operating system at a time, where the operating system can only be upgraded and not downgraded. As such, in order to test an application across a variety of devices and operating systems, a developer may need identical devices, where each device has a different version of an operating system. The developer may need to test an application across identical devices with different operating-system versions because the application may perform differently depending on the version of the operating system, even if the device itself is the same. Further, when performing the application testing, the process of switching between different devices may take a lot of time.

As the fragmentation of the mobile-device market increases, it may be desirable to perform automatic testing of test scenarios on multiple devices (as opposed to performing only manual execution of test scenarios on each device, one by one). It may be desirable to provide an automatic execution unit and/or provide recorded test scenarios across multiple devices. Therefore, with certain embodiments of the present invention, a developer may perform automatic testing of test scenarios across multiple devices (where each test scenario is properly tested across multiple devices), instead of requiring the developer to manually test each test scenario with each device, one by one.

In view of the above, certain embodiments of the present invention are directed to a method and system which can remotely access a plurality of mobile devices. With certain embodiments of the present invention, the method and system may access the mobile devices in a manner similar to accessing the mobile devices by means of their native interfaces. With certain embodiments of the present invention, a developer can more easily access any desired device and seamlessly control the device. Certain embodiments may provide a life-like, real-time interaction with a remote mobile device, as if the remote mobile device was in the developer's hand.

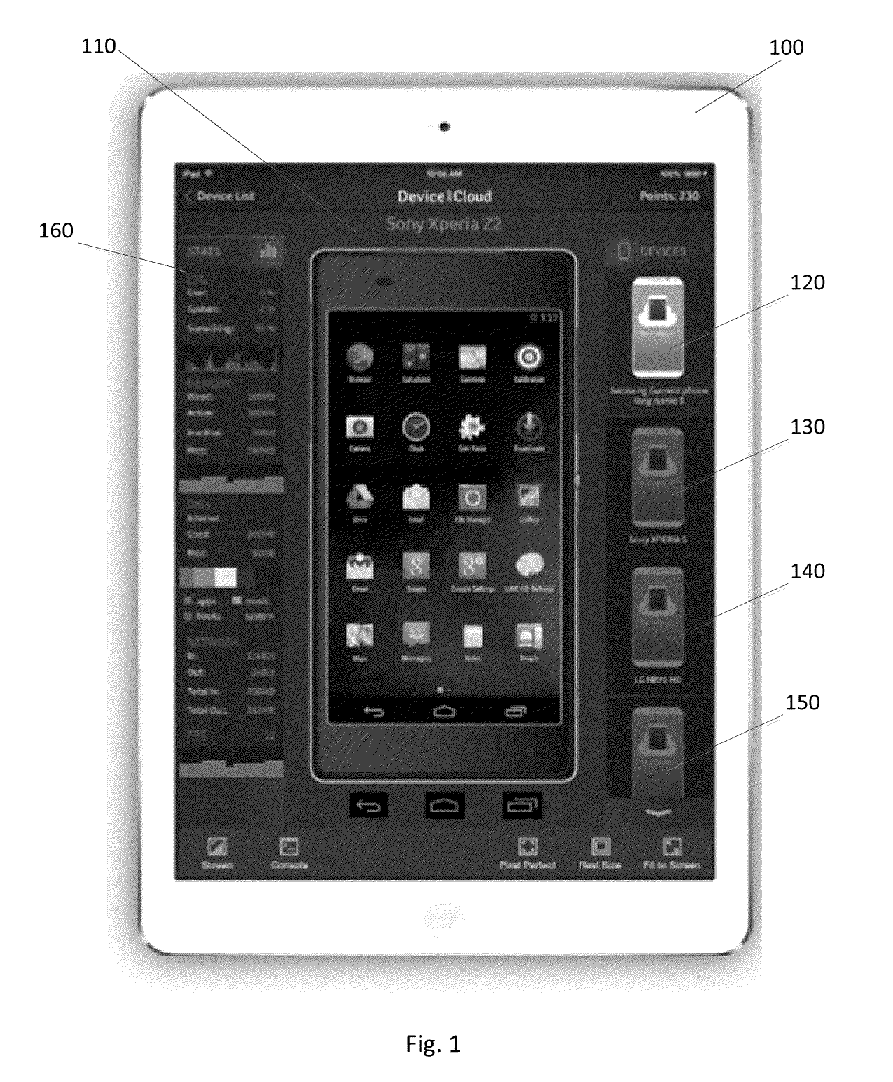

FIG. 1 illustrates an example user interface of an end-user device in accordance with certain embodiments of the present invention. The end-user device may be used by an application developer. Referring to FIG. 1, the developer may use end-user device 100 (such as a tablet or any other device) to remotely access any other device that is placed in a datacenter (such as a plurality of mobile devices). Interface 110 may list the plurality of mobile devices (120, 130, 140, and 150) that may be remotely accessed. Referring to FIG. 1, interface 110 displays mobile device “Sony Xperia Z2”. As the developer remotely interacts with “Sony Xperia Z2” via interface 110, interface 110 may provide statistics 160 relating to the operation of mobile device “Sony Xperia Z2”. Statistics 160 may relate to how the application (which is uploaded on a remote device) impacts the CPU, memory, battery usage, and how the application behaves under different network conditions (e.g., 3G, 4G, WiFi). For example, with regard to memory, certain embodiments may display the amount of memory that is active, inactive, and/or free. With regard to disk space, certain embodiments may display the amount of disk space that is used and the amount of disk space that is free. Also, certain embodiments may display how the disk space is allocated among a variety of areas (such as among apps, music, books, and system). In view of the above, certain embodiments of the present invention may provide life-like interaction with remote mobile devices. The statistics may help to understand how the application impacts certain components of the mobile device.

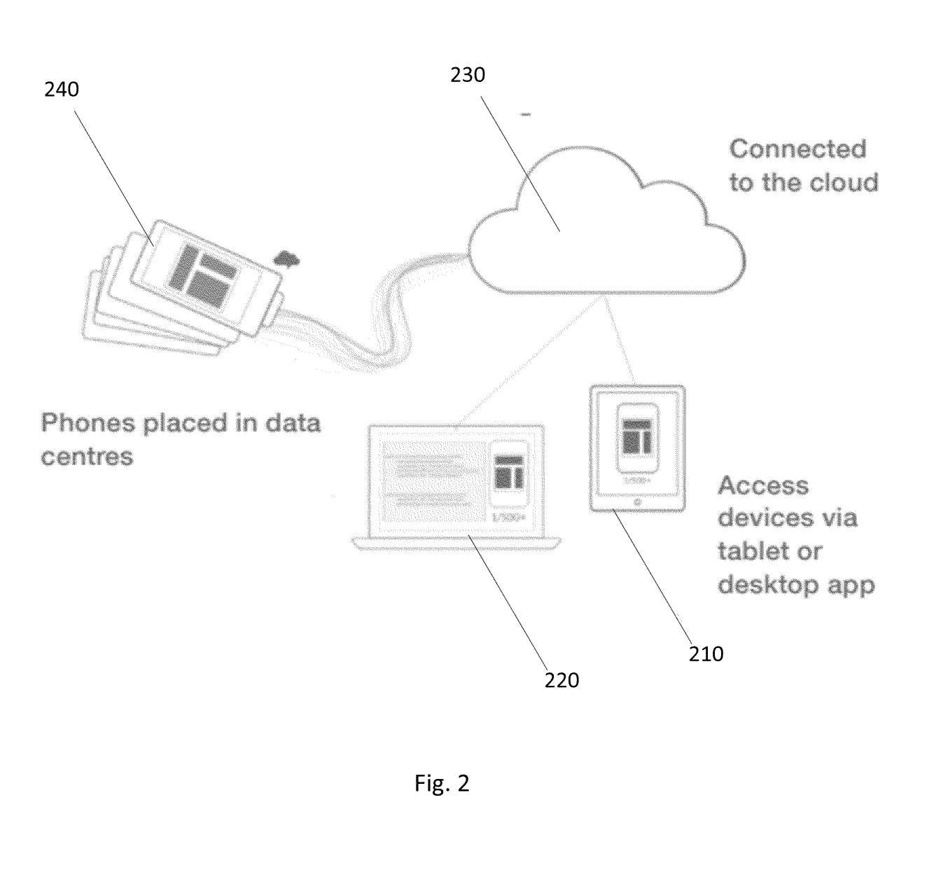

FIG. 2 illustrates an example configuration in accordance with certain embodiments of the present invention. An end-user device (such as tablet 210 or laptop 220) may be connected to a plurality of remote mobile devices 240 via a network 230. The mobile devices 240 may comprise the different types of mobile devices that the user/developer wishes to develop applications for. These mobile devices 240 may be physically placed in one or more data centers. Each of the mobile devices may be accessed by the end-user device (210 or 220) via network 230. As such, a developer may use an end-user device to remotely access and to remotely control a wide variety of different mobile devices 240. As described above, a developer may use the end-user device to test a variety of test scenarios on each of the different mobile devices 240. Any response by any of the different mobile devices 240 to a test scenario may be recorded. The recorded response may be viewed real-time or may be viewed later by the developer.

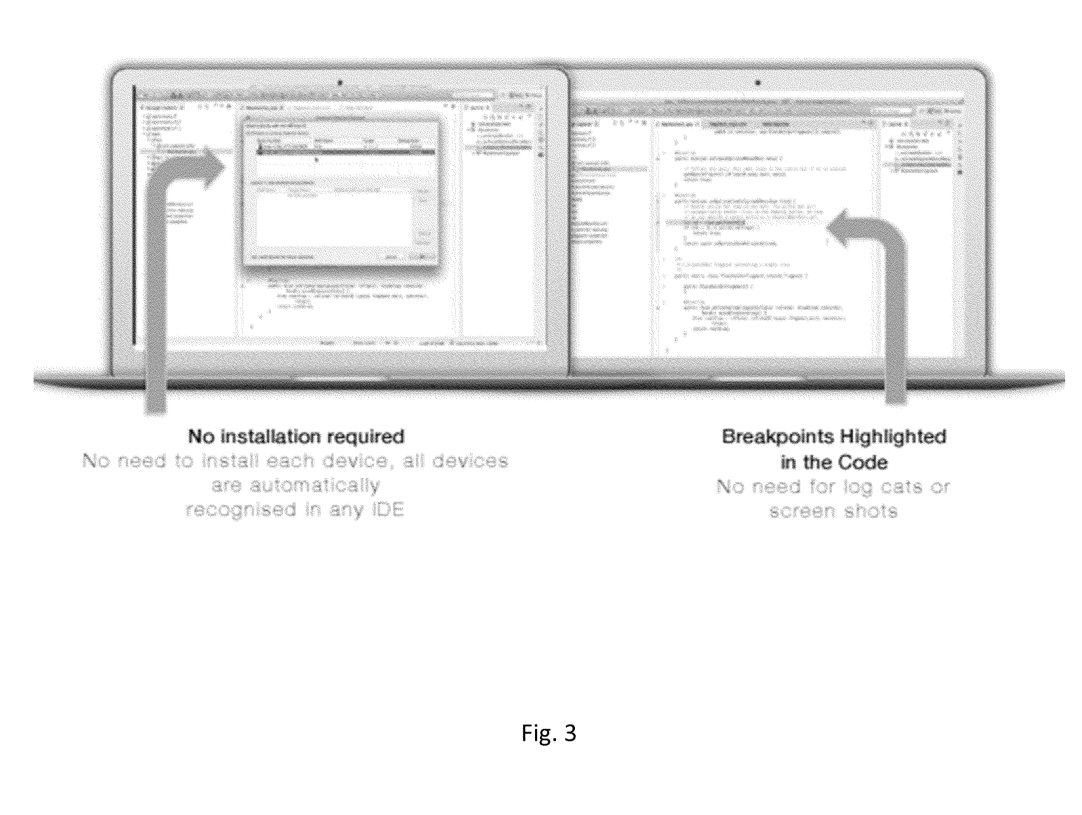

FIG. 3 illustrates some benefits provided by certain embodiments of the present invention. When using certain embodiments of the present invention, the end-user device may use an integrated development environment (IDE) to recognize each accessible remote device. In other words, an IDE of certain embodiments may recognize each of the different mobile devices 240 that the developer wishes to develop an application for.

Further, certain embodiments may generate breakpoints, and may highlight the portion of the code at which each breakpoint occurs. By generating and highlighting breakpoints, certain embodiments of the present invention may reduce the need for textual logs or the need for screen shots, for example.

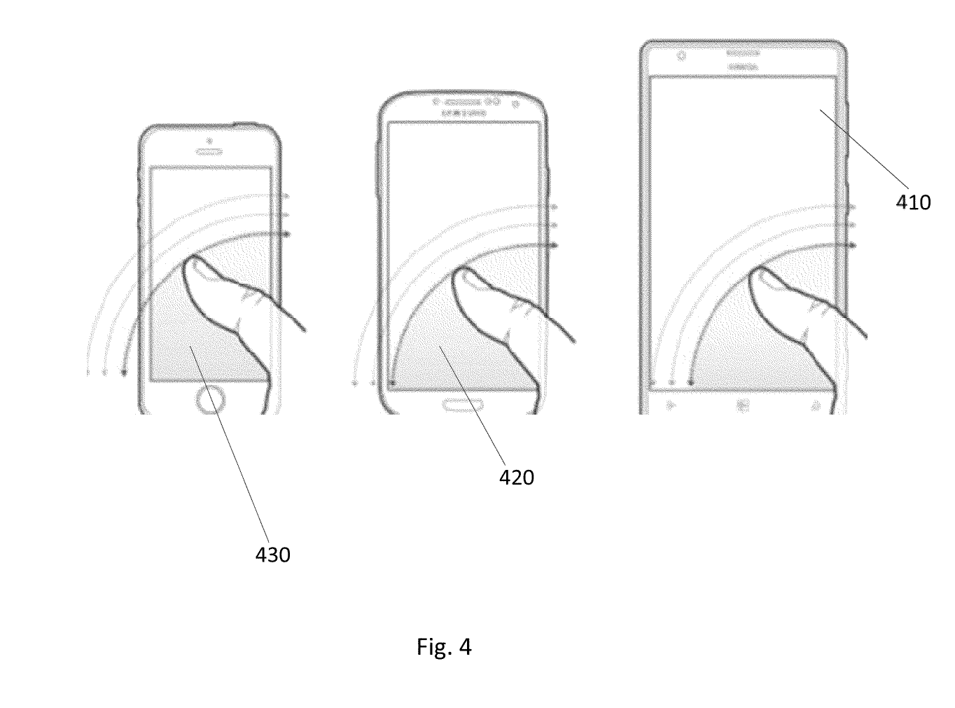

FIG. 4 illustrates providing inputs which may correspond to a test scenario, in accordance with certain embodiments of the present invention. As described above, in the course of developing an application for different devices, a developer may wish to input certain test scenarios for each of the different devices. For example, a developer may provide an input (such as a manual “swipe” or “tap,” for example) to a mobile device 410 (where mobile device 410 may correspond to one device of mobile devices 240). The provided input may be reproduced/propagated in at least one of the plurality of remote mobile devices (420, 430). In certain embodiments, the propagation of the provided input may occur in real-time. In certain embodiments, the provided input may be stored for later propagation on other remote mobile devices. Further, once the input is provided by a developer/user, certain embodiments of the invention may perform a translation of the provided input (as provided by end-user device 220, for example) into an equivalent/corresponding input to be provided to remote mobile devices (410, 420, 430). The provided input may be stored/translated by the end-user device, by a physical device unit, by a virtual device unit, and/or by a physical device agent, as described in more detail below. As one example of translating a provided input, the length of a manual “swipe” that is provided to mobile device 410 may be resized in accordance with the technical characteristics of remote mobile device 420 (where remote mobile device 420 and remote mobile device 410 may have different physical dimensions). As such, a “swipe” input may be translated into a larger swipe or a smaller swipe, depending on the physical dimensions of the remote mobile device to which the input is provided. In view of the above, once a developer performs an input on the mobile device 410, the input may be saved to be applied to a remote device at the present time, or at a later time. Further, the input may be translated/modified in accordance with the parameters of the remote mobile devices to which the input is to be applied to provide equivalent/corresponding inputs. The parameters may correspond to the specific technical characteristics of each remote mobile device. For example, the parameters may correspond to the physical dimensions of each device, the operating system of each device, and/or the hardware specifications of each device, for example. In certain embodiments of the present invention, the provided input may be saved and translated/modified into equivalent/corresponding inputs. Further, in certain embodiments, the resulting behaviors that occur on the remote mobile devices may also be saved for later viewing/playback. In view of the above, certain embodiments of the present invention may enable test touching on one device and propagation of the inputs/events to other devices at the same time. Embodiments of the present invention allow a developer to record a session of providing inputs, and embodiments of the present invention allow sharing of the recorded session with a team of developers so that the team may fix and find the development issues.

As described above with respect to FIG. 2, in order to provide access and control of a mobile device (within mobile devices 240), a hardware or software bridge may pipeline one or more mobile device interfaces via a network, usb port, and/or bluetooth port to a remote controller (where the remote controller may correspond to an end-user device (210 or 220) of a developer, for example). As described above, a developer may operate the remote controller to develop an application for the respective mobile device. The network may be a local or global network. The network may be a wired or a wireless network.

With certain embodiments of the present invention, the software bridge may be implemented on a low level of a mobile device's Operating System, on the driver or controller layer, for example.

With certain embodiments of the present invention, data to and from a wired communication port of the mobile device may be streamed via a network to and from the end user device.

Data to/from any component may depend on the type of component. Input or output of the mobile device may be streamed to the end user device via the network.

As described above, when a developer/user provides an input to a mobile device, the input that is provided by the developer/user may be translated to an equivalent/corresponding input that is specific to the technical characteristics of each remote mobile device (of remote mobile devices 240). With certain embodiments of the present invention, component-specific data (that may be specific to each remote mobile device) may be translated on the server infrastructure in both directions (from/to mobile device; and to/from the end user device) to achieve a native data standard on any mobile device and any end user device (the end user device being used by a developer, for example).

For example, in order to pipeline the images/video of a screen of a remote mobile device (to the developer), there may be a need to extract raw image data from the low level of the mobile device operating system on the (driver or controller) layer or from a screen interface (for example an mipi interface). The data may then be encoded/compressed to a video format (such as h264 or h265, for example) by a hardware or software encoder. The video format may then be transmitted to the end-user device of the developer.

With certain embodiments of the present invention, the audio/video stream from the remote mobile device may be configured in accordance with the available bandwidth. Certain embodiments of the present invention may utilize hardware video encoders and different audio video transformations between device and encoder interfaces.

As described above, the controller (corresponding to the end user device of the developer) may be a laptop or desktop computer. The controller may also be any other type of mobile device that best fits the use case and/or user experience scenario. For example, the controller of a remote mobile device may be a tablet device that controls remote mobile devices like smartphones, tablets, smartwatches, and/or wearable screens.

A debugger application may run on a client-side operating system, and the debugger application may be able to connect to the remote devices and may function as the debugger application would normally function on the remote devices.

With certain embodiments of the present invention, a secure network tunnel may be established between the debugging service provider on the device and the client side operating system.

The client side operating system may be software that is tricked/manipulated/configured into being in a state that would occur if the remote device were being used locally by the developer. This may be achieved by means of secure network tunneling between the remote mobile device and the client side operating system.

On the server side, certain embodiments of the present invention may provide mobile devices and virtual machines with a software bridge. On the client side, certain embodiments may provide a tablet or smartphone (as a remote device controller). On the client side, certain embodiments may also provide a laptop and/or desktop computer with a debugger bridge client application and user specific development environment (with an end user specific OS and integrated-development-environment (IDE)).

Certain embodiments of the present invention may provide another implementation that allows a user (developer or mobile application platform client) to “try before you buy” an application on a specific mobile application platform (such as iOS AppStore, for Android Google Play, Amazon Appstore, etc) without installing the application on the specific mobile device. On the server side, mobile devices and/or virtual machines with software bridges may be provided. On the specific mobile application platform, additional features may be implemented that enable remote controlling of an application (for example, a game) without installing the application on the end user mobile device. A user can immediately open and control an application or game without installation. The application or game may be streamed from the server side to the end user device, and the user can control the remote device.

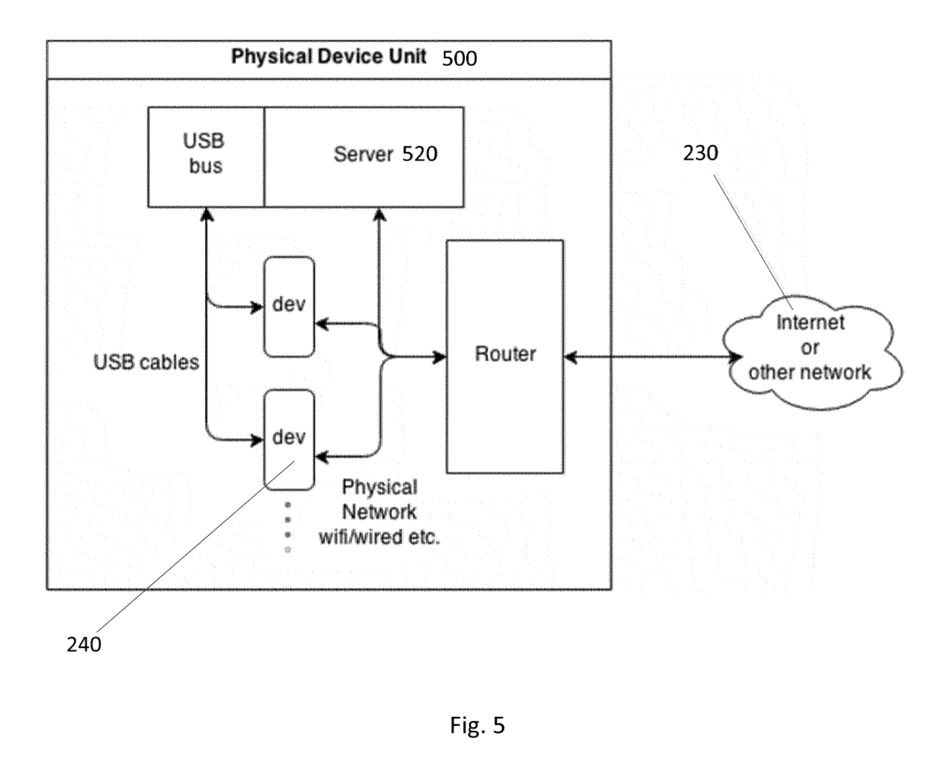

Referring to FIG. 5, a physical device unit (PDU) 500 may be a part of the system which facilitates access to physical devices. The physical devices may be remote mobile devices 240 that are to be remotely accessed/controlled by a user/developer. The PDU may be self contained and thus can be replicated, relocated, and connected to various public or private networks. Server 520 may be a physical computer that is running software which controls access and brokers client access. According to certain embodiments of the present invention, devices 240 may be connected to the controlling server 520 via both a network connection and a USB connection at the same time, and the devices may be running a software program (see physical data agent (PDA), as described below) to facilitate transfer of relevant data. These connections may transfer various data between the devices and the server. Outbound video streams and external (client) connections may be routed in the same computer network to possibly provide the most direct route between the client and the device. Outbound communication can be transmitted via network 230.

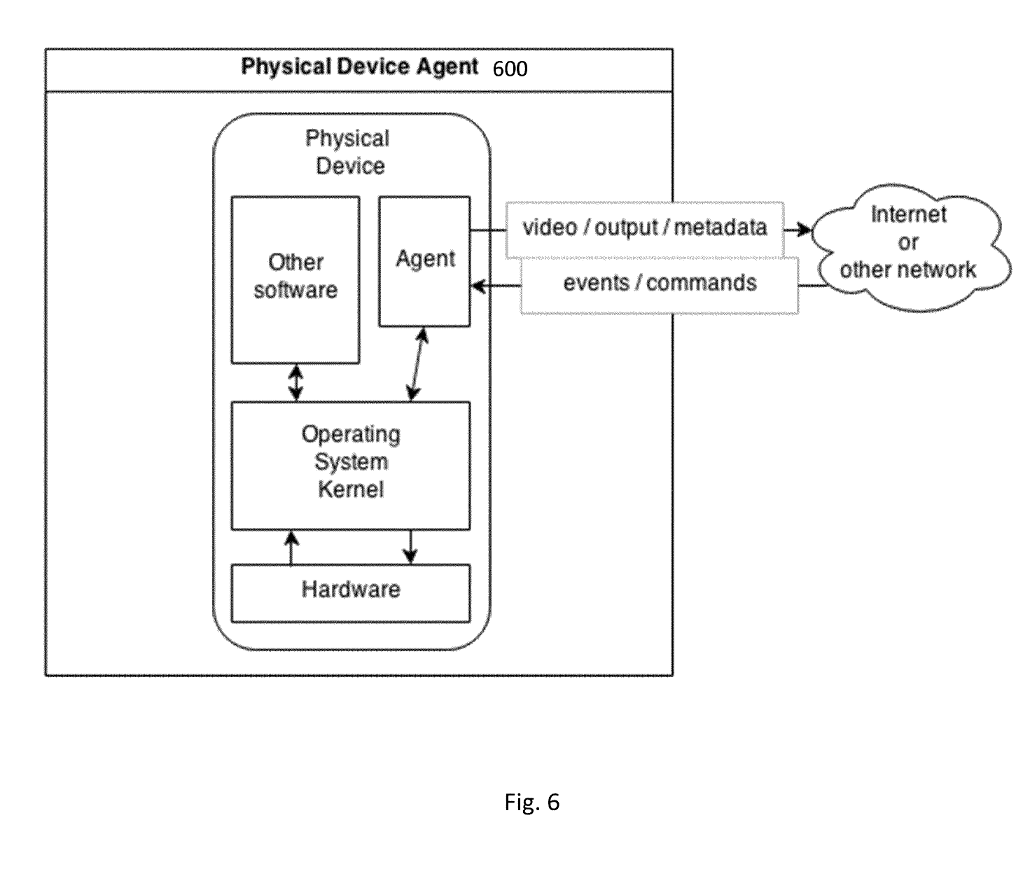

Referring to FIG. 6, physical device agent (PDA) 600 may be a software program that is running on a physical device, facilitating exchange of relevant data, such as, but not limited to: video stream, system log stream, usage data, events, notifications and commands. As such, after providing a test scenario to a remote mobile device, a developer may be able to view a video stream, a system log stream, a usage data, events, notifications, and/or commands from the PDA, in order to determine a response by the remote mobile device to the test scenario. As described above, PDA may be running on each of mobile devices 240 (as shown by FIG. 5). The PDA may be compatible with a wide range of devices from various vendors and may provide a unified way to communicate with any device that is running it. The PDA may also be used to monitor low level operating system software and to alter the behavior of the device (i.e., by issuing specific commands to the operating system kernel and/or shell).

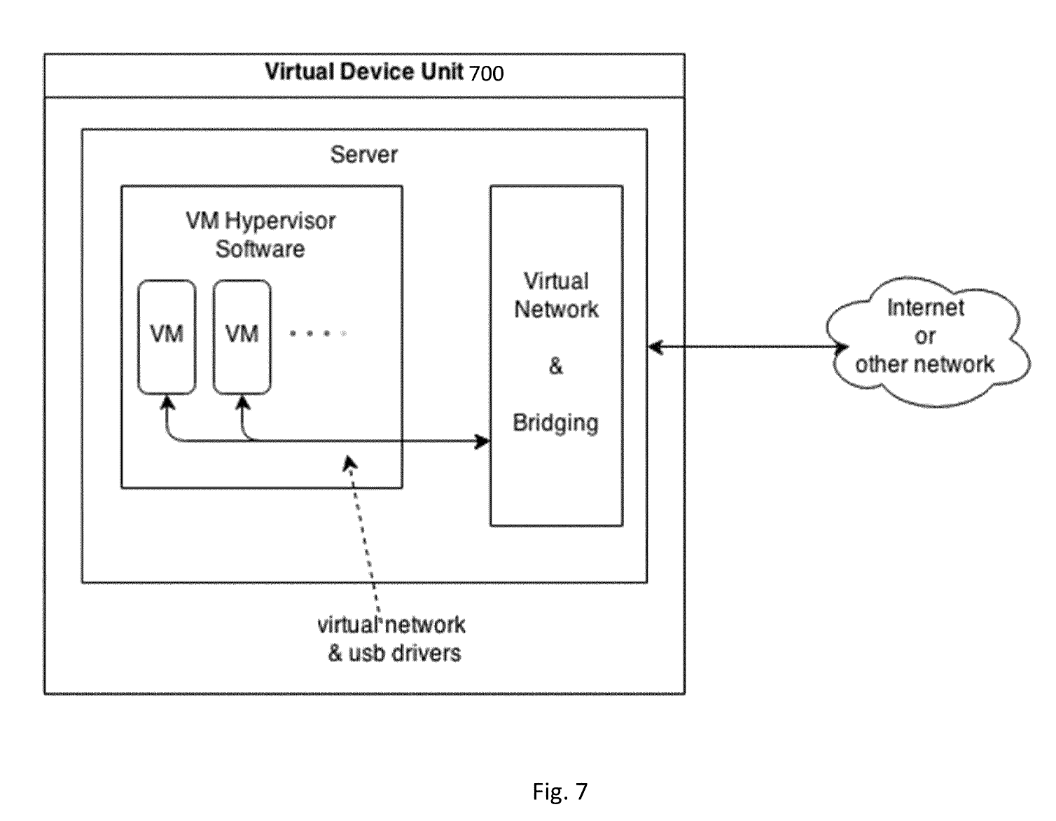

Referring to FIG. 7, a virtual device unit (VDU) 700 may be a part of a system which facilitates access to virtual devices. Embodiments which utilize a VDU may allow a developer/user to remotely access virtual devices, where the virtual devices represent the mobile devices for which the developer/user wishes to develop applications for. The VDU may be self contained and thus may possibly be replicated, relocated, and connected to various public or private networks. The Server of VDU may be a physical computer that runs software, including, for example: a VM hypervisor, virtual network drivers, access control programs, and bridging programs. VM (Virtual Machine) hypervisor software may be controlled and may spawn virtual machines (VMs) on demand, when they are needed. PDA may not be required because VM hypervisor may already provide means to communicate with VMs. VMs may be used instead of physical devices, and VMs may run mobile operating systems. VDU may provide the same interfaces as PDU to the user.

With certain embodiments of the present invention, a system can comprise any number of PDUs and VDUs, containing any number of devices and virtual devices.

With certain embodiments of the present invention, a system may connect the remote mobile device (for example, smartphone, smartwatch or wearable screen like Google Glass) with end user devices (pc, laptop, smartphone and/or tablet) as a controller.

With certain embodiments, a software bridge (i.e., an Agent) may be a software program that runs on the remote mobile device, and may provide communication in both sides to the server, and the server may communicate with end-user devices to transfer and translate mobile device interface specific events and data.

With certain embodiments, a debugger application (running on an end user device) may be able to connect to the remote mobile device and function as it normally would (like the mobile device is connected to the end user device).

With certain embodiments, an end user device (for example, a tablet) may be a controller for the remote mobile device. Input events and data from the end user device may be streaming and may be injected to the remote mobile device. Output events and data from the remote mobile device may be streamed to the end user touch device. Here, a server may act as the middleman to transfer and translate platform specific data in both ways.

With certain embodiments, the remote mobile device on the server side can also be a virtual machine (as described above) and may behave like a normal physical mobile device.

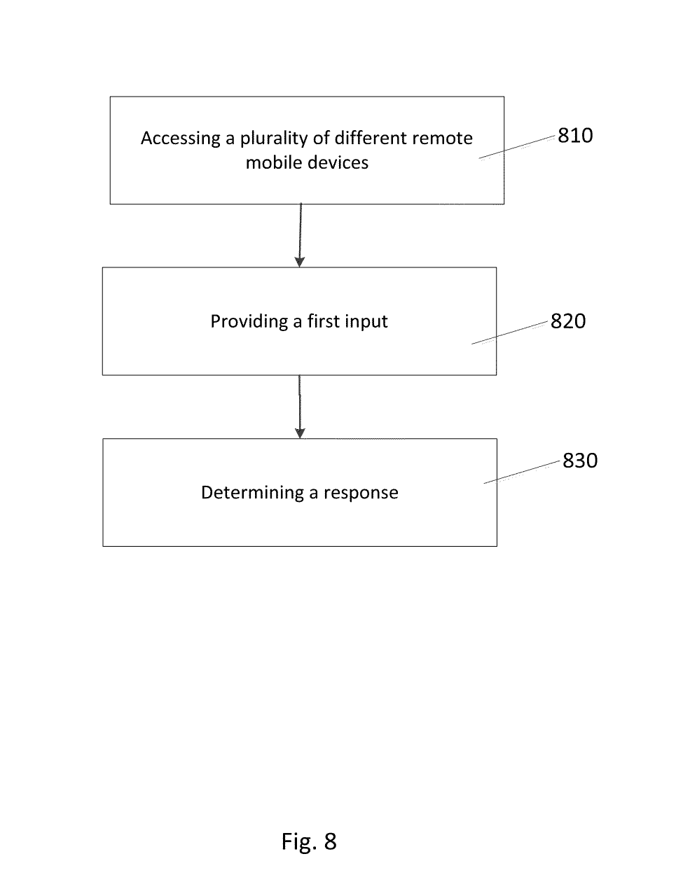

FIG. 8 illustrates a flowchart of a method in accordance with certain embodiments of the invention. The method illustrated in FIG. 8 includes, at 810, accessing, by an end-user device, a plurality of different remote mobile devices. Different technical characteristics exist across the different remote mobile devices. The method may also include, at 820, providing a first input. The first input is translated into a second input. The second input is received by at least one remote mobile device. The first input is translated into the second input based on the technical characteristics specific to the at least one remote mobile device. The method may also include, at 830, determining a response to the second input by the at least one remote mobile device.

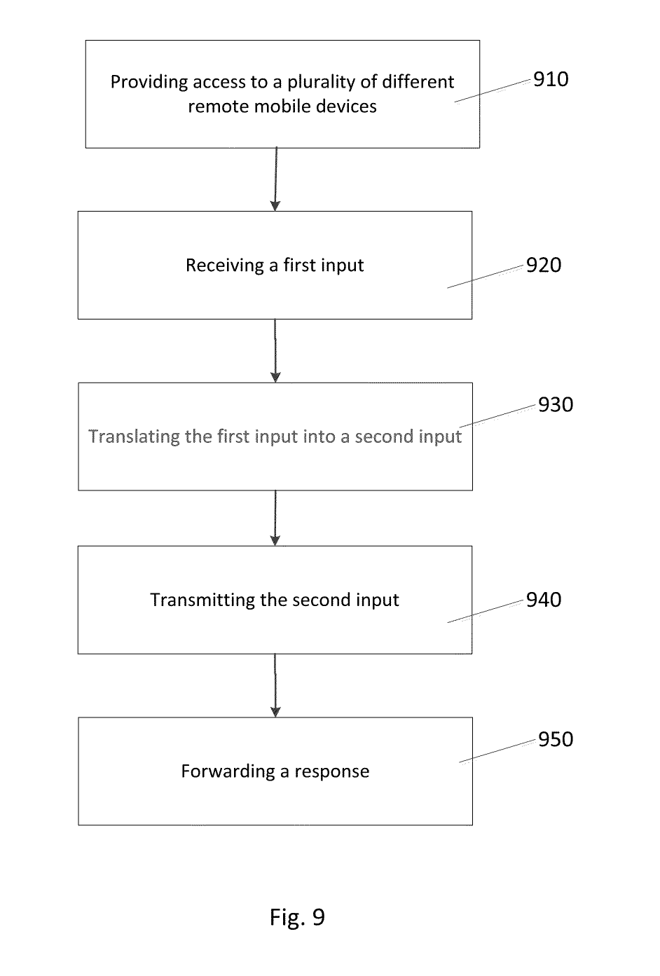

FIG. 9 illustrates a flowchart of a method in accordance with certain embodiments of the invention. The method illustrated in FIG. 9 includes, at 910, providing, by a device unit, access to a plurality of different remote mobile devices for an end-user device. Different technical characteristics exist across the different remote mobile devices. The method may also include, at 920, receiving a first input from the end-user device. The method may also include, at 930, translating the first input into a second input. The first input is translated into the second input based on technical characteristics specific to at least one remote mobile device. The method may also include, at 940, transmitting the second input to the at least one remote mobile device. The method may also include, at 950, forwarding a response by the at least one remote mobile device to the second input. The response is forwarded to the end-user device.

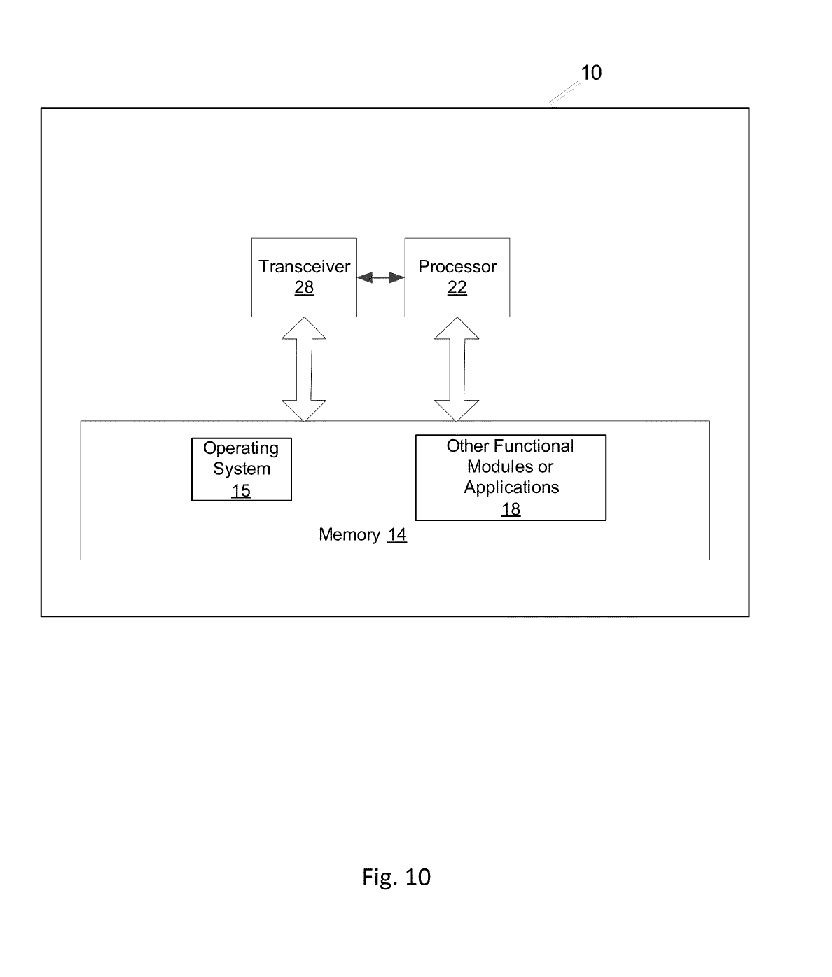

FIG. 10 illustrates an apparatus 10 according to another embodiment. Apparatus 10 may be an end-user device, a mobile device, physical device unit, physical device agent, a network node, and/or a virtual device unit, for example.

Apparatus 10 includes a processor 22 for processing information and executing instructions or operations. Processor 22 may be any type of general or specific purpose processor. While a single processor 22 is shown in FIG. 10, multiple processors may be utilized according to other embodiments. In fact, processor 22 may include one or more of general-purpose computers, special purpose computers, microprocessors, digital signal processors (“DSPs”), field-programmable gate arrays (“FPGAs”), application-specific integrated circuits (“ASICs”), and processors based on a multi-core processor architecture, as examples.

Apparatus 10 further includes a memory 14, coupled to processor 22, for storing information and instructions that may be executed by processor 22. Memory 14 may be one or more memories and of any type suitable to the local application environment, and may be implemented using any suitable volatile or nonvolatile data storage technology such as a semiconductor-based memory device, a magnetic memory device and system, an optical memory device and system, fixed memory, and removable memory. For example, memory 14 can be comprised of any combination of random access memory (“RAM”), read only memory (“ROM”), static storage such as a magnetic or optical disk, or any other type of non-transitory machine or computer readable media. The instructions stored in memory 14 may include program instructions or computer program code that, when executed by processor 22, enable the apparatus 10 to perform tasks as described herein.

Apparatus 10 may also include one or more antennas (not shown) for transmitting and receiving signals and/or data to and from apparatus 10. Apparatus 10 may further include a transceiver 28 that modulates information on to a carrier waveform for transmission by the antenna(s) and demodulates information received via the antenna(s) for further processing by other elements of apparatus 10. In other embodiments, transceiver 28 may be capable of transmitting and receiving signals or data directly.

Processor 22 may perform functions associated with the operation of apparatus 10 including, without limitation, precoding of antenna gain/phase parameters, encoding and decoding of individual bits forming a communication message, formatting of information, and overall control of the apparatus 10, including processes related to management of communication resources.

In an embodiment, memory 14 stores software modules that provide functionality when executed by processor 22. The modules may include an operating system 15 that provides operating system functionality for apparatus 10. The memory may also store one or more functional modules 18, such as an application or program, to provide additional functionality for apparatus 10. The components of apparatus 10 may be implemented in hardware, or as any suitable combination of hardware and software.

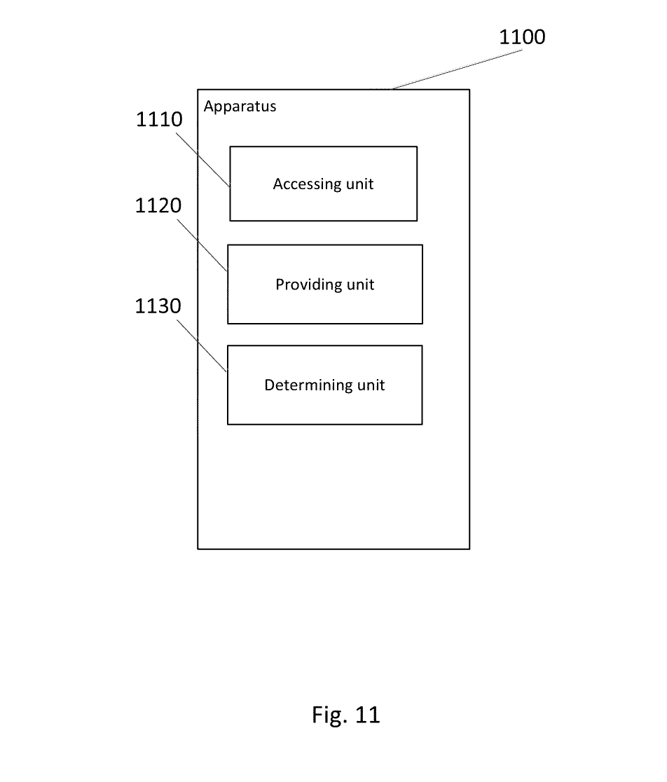

FIG. 11 illustrates another apparatus in accordance with certain embodiments of the invention. Apparatus 1100 can be an end-user device, for example. Apparatus 1100 can include an accessing unit 1110 that accesses a plurality of different remote mobile devices. Different technical characteristics exist across the different remote mobile devices. Apparatus 1100 may also include a providing unit 1120 that provides a first input. The first input is translated into a second input, the second input is received by at least one remote mobile device, and the first input is translated into the second input based on the technical characteristics specific to the at least one remote mobile device. Apparatus 1100 may also include a determining unit 1130 that determines a response to the second input by the at least one remote mobile device.

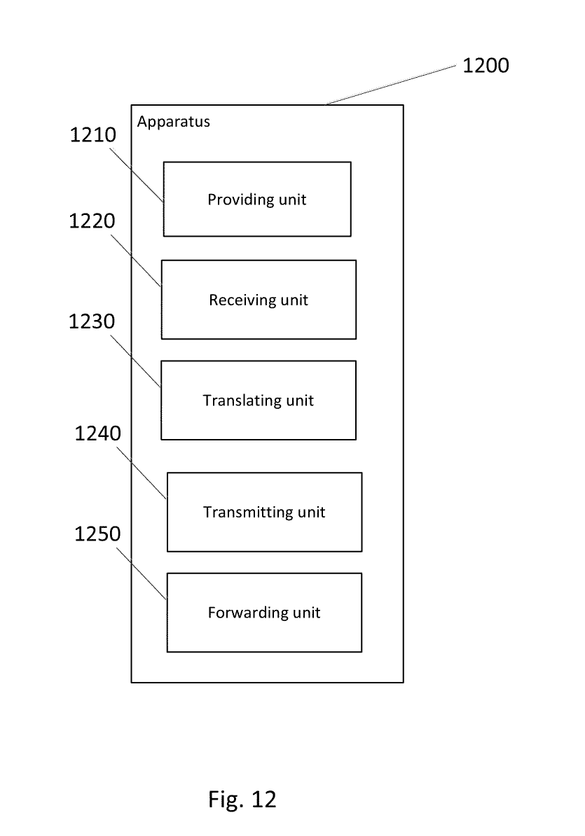

FIG. 12 illustrates another apparatus in accordance with certain embodiments of the invention. Apparatus 1200 can be a physical device unit or a virtual device unit, for example. Apparatus 1200 can include a providing unit 1210 that provides access to a plurality of different remote mobile devices for an end-user device. Different technical characteristics exist across the different remote mobile devices. Apparatus 1200 may also include a receiving unit 1220 that receives a first input from the end-user device. Apparatus 1200 may also include a translating unit 1230 that translates the first input into a second input. The first input is translated into the second input based on technical characteristics specific to at least one remote mobile device. Apparatus 1200 may also include a transmitting unit 1240 that transmits the second input to the at least one remote mobile device. Apparatus 1200 may also include a forwarding unit 1250 that forwards a response by the at least one remote mobile device to the second input. The response is forwarded to the end-user device.

The described features, advantages, and characteristics of the invention can be combined in any suitable manner in one or more embodiments. One skilled in the relevant art will recognize that the invention can be practiced without one or more of the specific features or advantages of a particular embodiment. In other instances, additional features and advantages can be recognized in certain embodiments that may not be present in all embodiments of the invention. One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention.

We claim:

1. A method, comprising:
accessing, by an end-user device, a plurality of different remote mobile devices, wherein different technical characteristics exist across the different remote mobile devices;
providing a first input, wherein the first input is translated into a second input, the second input is received by at least one remote mobile device, and the first input is translated into the second input based on the technical characteristics specific to the at least one remote mobile device; and
determining a response to the second input by the at least one remote mobile device.

2. The method according to claim 1, wherein the providing the first input comprises providing a test scenario.

3. The method according to claim 2, wherein the test scenario comprises a swipe input, and the translation of the test scenario comprises translating the test scenario based on a physical dimension of the at least one remote mobile device.

4. The method according to claim 1, wherein the accessing comprises accessing the plurality of different remote mobile devices by the end-user device via a network.

5. The method according to claim 1, wherein the plurality of different remote mobile devices comprises at least one virtual machine that is provided by a virtual device unit.

6. The method according to claim 1, wherein the determining the response comprises converting data from a low level of an operating system of the at least one remote mobile device to a format viewable by the end-user device.

7. An apparatus, comprising:
at least one processor; and
at least one memory including computer program code,
the at least one memory and the computer program code configured, with the at least one processor, to cause the apparatus at least to
access a plurality of different remote mobile devices, wherein different technical characteristics exist across the different remote mobile devices;
provide a first input, wherein the first input is translated into a second input, the second input is received by at least one remote mobile device, and the first input is translated into the second input based on the technical characteristics specific to the at least one remote mobile device; and
determine a response to the second input by the at least one remote mobile device.

8. The apparatus according to claim 7, wherein the providing the first input comprises providing a test scenario.

9. The apparatus according to claim 8, wherein the test scenario comprises a swipe input, and the translation of the test scenario comprises translating the test scenario based on a physical dimension of the at least one remote mobile device.

10. The apparatus according to claim 7, wherein the accessing comprises accessing the plurality of different remote mobile devices by the apparatus via a network.

11. The apparatus according to claim 7, wherein the plurality of different remote mobile devices comprises at least one virtual machine that is provided by a virtual device unit.

12. The apparatus according to claim 7, wherein the determining the response comprises converting data from a low level of an operating system of the at least one remote mobile device to a format viewable by the apparatus.

13. A computer program product, embodied on a non-transitory computer readable medium, the computer program product configured to control a processor to perform a method according to claim 1.

14. A method, comprising:
providing, by a device unit, access to a plurality of different remote mobile devices for an end-user device, wherein different technical characteristics exist across the different remote mobile devices;
receiving a first input from the end-user device;
translating the first input into a second input, wherein the first input is translated into the second input based on technical characteristics specific to at least one remote mobile device;
transmitting the second input to the at least one remote mobile device; and
forwarding a response by the at least one remote mobile device to the second input, wherein the response is forwarded to the end-user device.

15. The method according to claim 14, wherein the receiving the first input comprises receiving a test scenario.

16. The method according to claim 15, wherein the test scenario comprises a swipe input, and the translation of the test scenario comprises translating the test scenario based on a physical dimension of the at least one remote mobile device.

17. An apparatus, comprising:
at least one processor; and
at least one memory including computer program code,
the at least one memory and the computer program code configured, with the at least one processor, to cause the apparatus at least to
provide access to a plurality of different remote mobile devices for an end-user device, wherein different technical characteristics exist across the different remote mobile devices;
receive a first input from the end-user device;
translate the first input into a second input, wherein the first input is translated into the second input based on technical characteristics specific to at least one remote mobile device;
transmit the second input to the at least one remote mobile device; and
forward a response by the at least one remote mobile device to the second input, wherein the response is forwarded to the end-user device.

18. The apparatus according to claim 17, wherein the receiving the first input comprises receiving a test scenario.

19. The apparatus according to claim 18, wherein the test scenario comprises a swipe input, and the translation of the test scenario comprises translating the test scenario based on a physical dimension of the at least one remote mobile device.

20. A computer program product, embodied on a non-transitory computer readable medium, the computer program product configured to control a processor to perform a method according to claim 14.
